(19) United States
(12) Patent Application Publication
(10) Pub. No.: US 2025/0269772 A1
(43) Pub. Date: Aug. 28, 2025

(54) CONFIGURED SEAT BACK AND REAR SEATING

(71) Applicant: VEXAS CORP., Liberty Hill, TX (US)

(72) Inventor: Aaron Gouldie, Leander, TX (US)

(73) Assignee: VEXAS CORP., Liberty Hill, TX (US)

(21) Appl. No.: 19/061,449

(22) Filed: Feb. 24, 2025

Related U.S. Application Data
(60) Provisional application No. 63/556,764, filed on Feb. 22, 2024.

(51) Int. Cl. B60N 2/30; B60N 2/36; B60N 2/75; B60N 3/02; B60N 3/10

(52) U.S. Cl. CPC B60N 2/3036; B60N 2/305; B60N 2/763; B60N 3/02; B60N 3/101; B60N 2002/363

(57) ABSTRACT

Apparatus and associated methods relate to a configured seat back and rear seating system. The system includes an affixed backrest extending along a longitudinal axis and a plurality of intersecting multi-modal rear vehicle seats independently pivotally coupled along a front of the multi modal seats configured such that the rear of the plurality of the seats may rotate along a front pivot. In a seating mode the plurality of rear seats is configured such that the rear of the seat intersects the longitudinal axis of the affixed backrest. In a stowage mode configured such that the at least one rear of the plurality of the rear vehicle seats are extended to couple to an extended rear portion of a front seat. In some embodiments, a configured seat back and rear seating system includes a seat back including a front rear seat system including a series of accessories.

### CROSS REFERENCE TO RELATED APPLICATIONS

This application claims the benefit of U.S. Application Ser. No. 63/556,764, titled “Multi-Modal Rear Vehicle Seat,” filed by Aaron Gouldie on Feb. 22, 2024.

This application incorporates the entire contents of the foregoing application(s) herein by reference.

### TECHNICAL FIELD

Various embodiments relate generally to vehicle accessory design.

### BACKGROUND

Rear seats in vehicles may, for example, be designed with versatility and comfort in mind, providing additional seating capacity. Golf carts may, for example, be used on golf courses to enhance the user's convenience and experience. Seat accessories, such as cushioned covers may, for example, be used to offer customization options to enhance comfort and functionality. Off-terrain vehicles may, for example, be designed to handle rugged landscapes safely.

### SUMMARY

Apparatus and associated methods relate to a configured seat back and rear seating system. The system includes an affixed backrest extending along a longitudinal axis and a plurality of intersecting multi-modal rear vehicle seats independently pivotally coupled along a front of the multi modal seats configured such that the rear of the plurality of the seats may rotate along a front pivot. In a seating mode the plurality of rear seats is configured such that the rear of the seats intersect the longitudinal axis of the affixed backrest. In a stowage mode the rear seats are configured such that at least one rear of the plurality of the rear vehicle seats are extended to couple to an extended rear portion of a front seat. In some embodiments, a configured seat back and rear seating system includes a seat back including a front rear seat system including a series of accessories.

Various embodiments may achieve one or more advantages. For example, some embodiments may enhance the audio experience for passengers, provide customizable audio control for different seating positions, and integrate seamlessly with the vehicle's design and functionality. Additionally, the inclusion of a controller in the rear allows for audio adjustments, catering specifically to the needs of rear passengers in potentially a four-seater configuration, thus offering an elevated level of audio personalization and control within the vehicle. Some embodiments may, for example, include a folding device. The folding device may, for example, be used to fold the seat into a rear storage area. Some embodiments include a sliding-folding device. The sliding-folding device may, for example, be used to fold the seat into a rear storage area. The storage area may, for example, include an elevated perimeter. The storage area may, for example, include groves to provide traction, and/or drainage for liquids. The storage area may, for example, be completely flat. A second storage area may, for example, be situated underneath the seat.

The details of various embodiments are set forth in the accompanying drawings and the description below. Other features and advantages will be apparent from the description and drawings, and from the claims.

### BRIEF DESCRIPTION OF THE DRAWINGS

FIG. 1 illustrates a configured seat back and rear seating in an illustrative use-case scenario.

FIG. 2A illustrates an exemplary configured seat back.

FIG. 2B illustrates an exemplary side view of a configured seat back.

FIG. 3A depicts a configured seat back and rear seating in an illustrative use-case scenario.

FIG. 3B depicts a configured seat back and rear seating in an illustrative use-case scenario.

FIG. 4 depicts a multi-modal rear seat embodiment.

FIG. 5 depicts a multi-modal rear seat embodiment.

FIG. 6 depicts a multi-modal rear seat embodiment.

FIG. 7 depicts a multi-modal rear seat folding configuration.

Like reference symbols in the various drawings indicate like elements.

### DETAILED DESCRIPTION OF ILLUSTRATIVE EMBODIMENTS

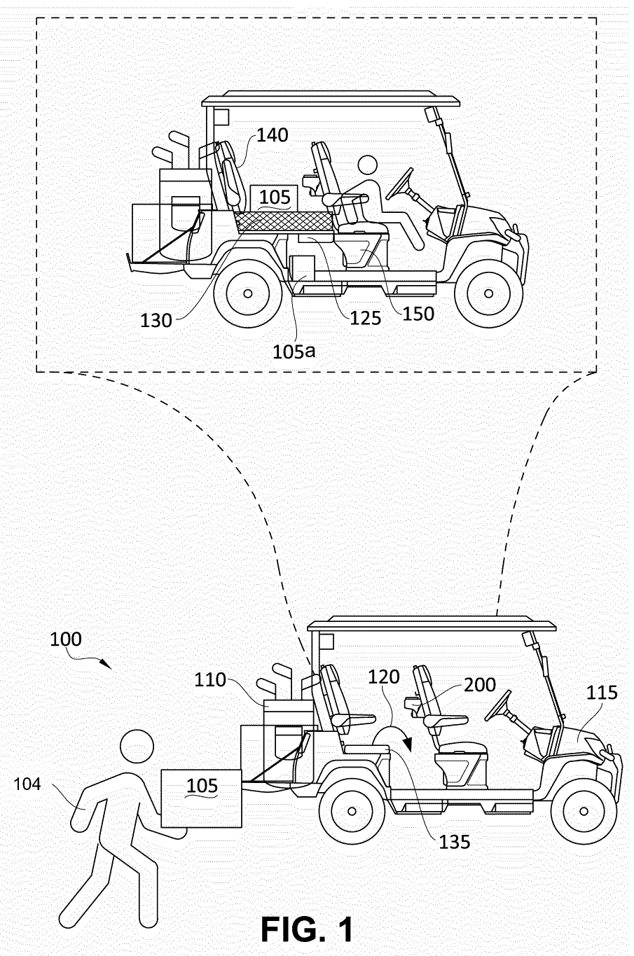

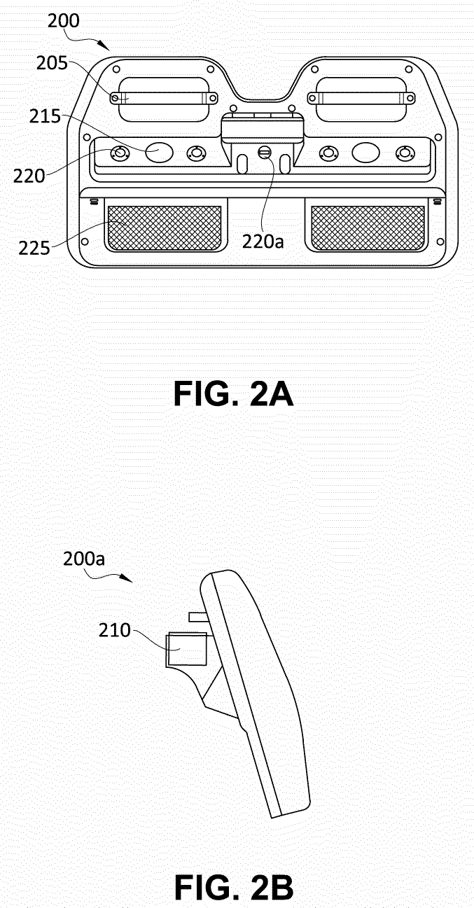

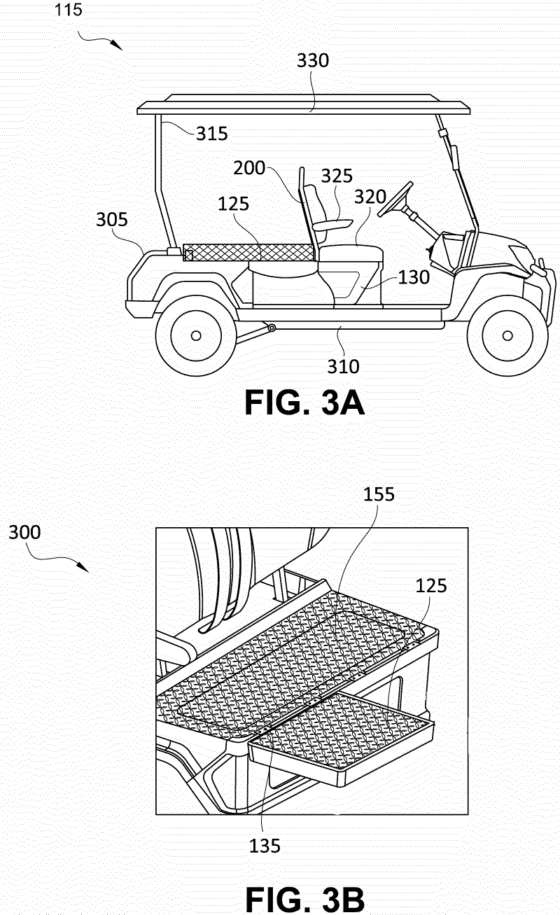

To aid understanding, this document is organized as follows. First, to help introduce discussion of various embodiments, a configured seat back and rear seating is introduced with reference to FIGS. 1-2B. Second, that introduction leads into a description with reference to FIGS. 3A-7 of some exemplary multi-modal rear seat embodiments and seating configurations.

FIG. 1 illustrates a configured seat back and rear seating in an illustrative use-case scenario 100. The illustrative use-case scenario 100 includes a user 104. The user 104 is carrying a cooler container 105. The container 105 is stowed onto the rear surface. A container 105a is stored on the floor of the vehicle. The container may, for example, include a cooler. The container may, for example, include a duffle bag. The container may, for example, include a lunch bag. The container may, for example, include stowage materials.

The illustrative use-case scenario includes a vehicle 115. A golf bag 110 is stowed on the rear of the vehicle. Additional items, including other storage containers, may, for example, be stored on the rear of the vehicle via an open trunk supported by a tether (e.g., cable affixed to the rear of vehicle).

The illustrative use-case scenario 100 includes rear seat configuration 125. The rear seat configuration may, for example, provide comfortable seating for passengers. The rear back seat 125 may, for example, be positioned into a folded position. The folded position may, for example, increase storage space when the seat is not in use. The rear seat 125 includes pivot 135. The rear seat may, for example, rotate along pivot 135 positioned in front of the seat. The rear seat 125 may, for example, rotate along the rotation path 120. The rear seat 125 as deployed along the path deploys a net 130.

The hinge may, for example, facilitate the transformation between seating and storage configurations. A mode change device is incorporated to enable the transition between different configurations of the seat module. The rear seat module includes a rear bottom seat 135. The rear bottom seat may, for example, offer additional seating capacity. The rear bottom seat may, for example, fold into a position. The folded position of the rear bottom seat may, for example, be used to create a flat surface for larger items. This feature is supported by a rear bottom seat hinge, which may, for example, assist in the folding device of the bottom seat to convert the seating into a flat storage area

The rear seat module in seat mode may, for example, be used to transport passengers. In this configuration, the rear back seat and the rear bottom seat provide seating. The rear back seat, along with its hinge, adjusts for comfort and safety, while the rear bottom seat offers additional seating capacity. This mode accommodates passengers, enhancing vehicle usability in settings where carrying individuals is necessary.

In folded mode, the rear seat module transforms the vehicle rear seats to maximize cargo capacity. This configuration involves folding the rear back seat into a position, converting the seating area into a flat trunk area. The rear bottom seat folds down, using its hinge to extend the rear flat space. This mode may, for example, be used to transport equipment, supplies, or cargo, making the vehicle versatile. The transition between seat and folded modes is facilitated by a mode change device, allowing for adjustments to cater to user needs for transport or cargo hauling. The mode change device may, for example, include a lock, such that a user may, for example, engage the lock to transition the rear seats between two modes.

The vehicle 115 includes a rear back rest 140. The back rest 140 may, for example, be affixed to the rear of the vehicle. The rear seat may, for example, direction may, for example, intersect the direction of the rear backrest. The rear seat may, for example, rotate onto a protrusion 150 extending from the rear of the front seat 200.

The vehicle may, for example, include a golf cart. The rear seat configuration includes a rear back seat. The rear seat configuration may, for example, be used to provide seating for passengers. The rear back seat 130 may, for example, fold into a flat position 130a, to increase cargo space. The flat position 130a may, for example, be facilitated by a rear back seat hinge. The rear seat configuration includes a rear bottom seat. The rear seat configuration may, for example, offer additional seating. This rear bottom seat can fold into a flat position, to expand the cargo area, supported by a rear bottom seat hinge.

The rear back seat provides seating. The seat folds into a flat position, labeled as, to increase trunk space. The rear back seat hinge supports the folding action of the seat. The mode change device controls the adjustment between the seat and folded positions, tailoring the configuration to specific needs. The bottom rear seat offers additional seating. It also folds down into a flat position, represented as, to extend the trunk space. The rear bottom seat hinge facilitates the folding of seat enabling a smooth transformation between seating and storage configurations.

In some embodiments, the rear seat module is equipped with a mode change device may, for example, enable seamless transitions between different functional modes. This device may, for example, allow the rear seat to alternate between seating for passengers and a flat configuration for cargo, depending on the immediate needs of the user. This adaptability may, for example, be used for optimizing space within the golf cart, making it suitable for varying activities such as transporting golf equipment or providing additional seating for passengers. The mode change device may, for example, be designed to be user-friendly, requiring minimal effort to activate and secure in either position, thereby enhancing the golf cart's utility without compromising on convenience or safety.

In some embodiments, the rear back seat may, for example, be designed to offer flexible seating options. The rear seat back may, for example, serve as a conventional seat for passengers but also has the capability to fold down into a flat position. This transformation is facilitated by a hinge 130b. The hinge may, for example, be able to support heavy weights, but also function to transition between modes. When folded, the rear back seat aligns with the golf cart's rear cargo area, effectively increasing the space available for larger items. This feature is particularly useful in scenarios where space optimization is crucial, such as during trips requiring additional supplies or equipment. The design focuses on providing quick and easy adjustments to accommodate changing needs while ensuring that the structural integrity and comfort of the seating are maintained.

In some embodiments, the rear bottom seat may, for example, extend the seating capacity of the golf cart. The rear bottom seat may, for example, be capable of folding into a flat position, using a hinge. This feature allows for an even greater expansion of the cargo area when needed, making it ideal for users who require versatile space solutions. The rear bottom seat is engineered to provide comfort when in use as a seat and stability when converted into a cargo space. This dual functionality is achieved without compromising the ease of transformation between modes, ensuring that users can quickly adapt the golf cart layout to suit their specific requirements at any given time.

FIG. 2A illustrates an exemplary configured front seat back 200. The configured front seat back 200 includes a pair of handles 205. The handle may, for example, enhance maneuverability and control of a passenger when seated. In some embodiments, the configured front seat back 200 may, for example, include touch screens. The touch screens may, for example, provide interactive access to the vehicle's systems.

The configured front seat back 200 includes speakers 215. The speakers may, for example, offer audio output for entertainment and alerts. Secondary controllers 220 are integrated into the configured front seat back 200. The secondary controllers may, for example, allow for the adjustment of various settings such as air conditioning modules. Some embodiments, may, for example, include secondary speakers. The configured front seat back 200 includes a charging port 220a. The charging point may, for example, facilitate the charging of electronic devices. Mesh netting 225 may, for example, be included in the configured front seat back 200. The mesh netting 225 may, for example, provides secure storage for personal items.

FIG. 2B illustrates an exemplary side view 200a of a configured seat back 200. A cup holding device 210 is included in the configured front seat back 200. The cup holder may, for example, keep beverages stable during travel.

FIG. 3A depicts a configured seat back and rear seating vehicle 115. The vehicle 115 includes a canopy 330. The vehicle 115 includes a foldable arm rest 325. The vehicle 115 includes an adjustable seat bottom 320 for the front seat. The vehicle 115 includes a seat pod 150 which is configured to reside under the font seat and includes configured to receive a lip of the rear seat when folded to support the foldable rear seat 125. The vehicle 115 includes a rear body 305. The rear body may, for example, include a trunk. The rear body may, for example, include a foldable trunk with a tether attachment. The vehicle includes a rear strut 315. The struts may, for example, be used to support the canopy.

FIG. 3B depicts a configured rear seating 300. The rear seating includes the rear seat 125. The rear seat 125 may, for example, be affixed to a pivot 135. The rear seat 125 may, for example, rotate from the bottom surface 155, to extend the surface with the bottom of the rear seat.

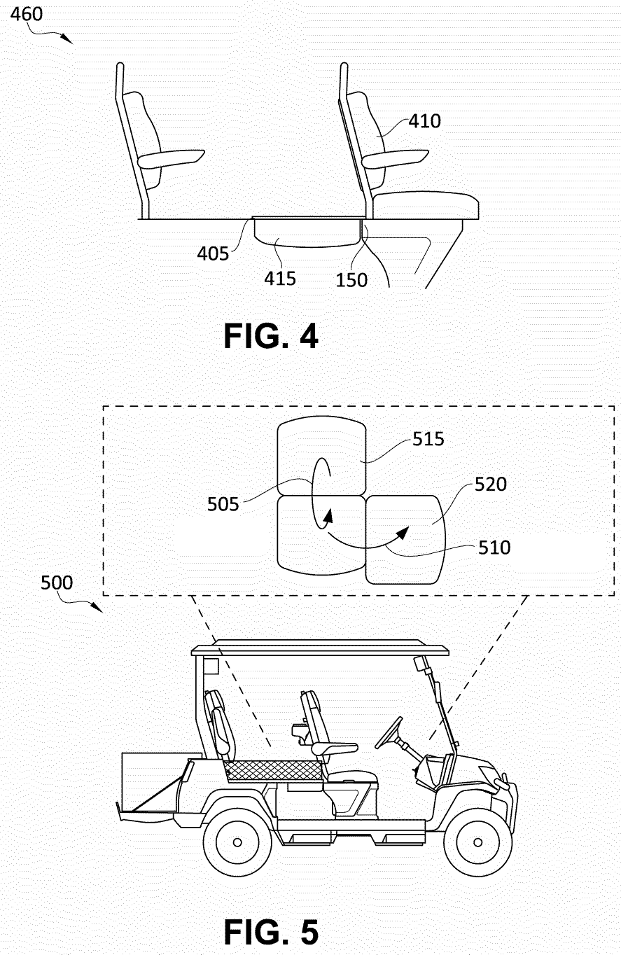

FIG. 4 depicts a multi-modal rear seat embodiment 460. The rear seat embodiment 460 includes a front back rest 410. The rear seat 415 may, for example, be decoupled from the rear seat and affixed to positions 405 to the front of the rear seat and to the protrusion extension 150 (e.g., the protrusion extending from the seat pod).

FIG. 5 depicts a multi-modal rear seat embodiment 500. The multi-modal rear seat embodiment 500 includes a rear seat 520 deployment from a starting position 515. The rear seat deployment includes a flipped movement 505. The rear seat deployment includes a rotation motion 510.

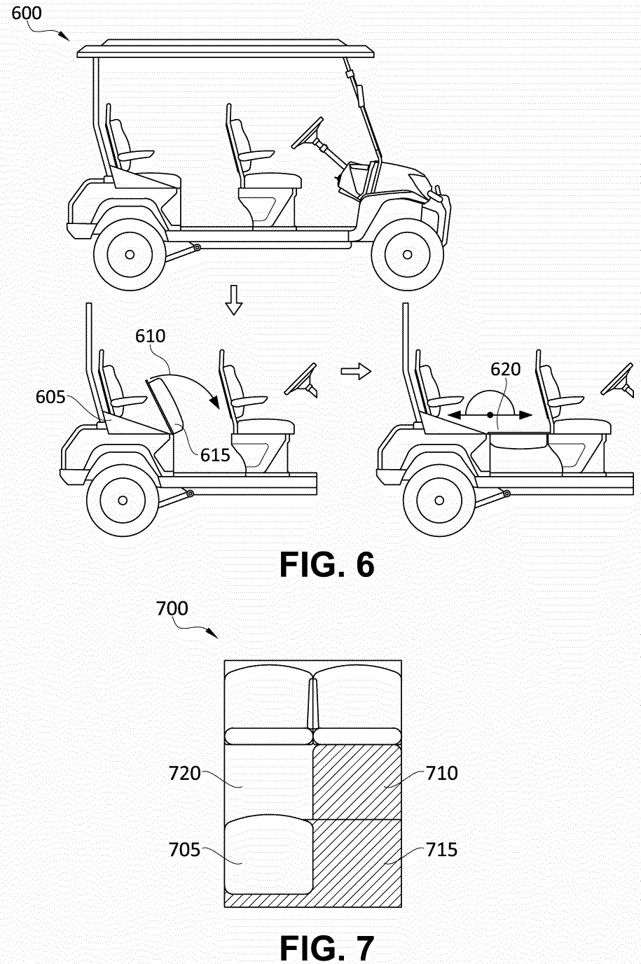

FIG. 6 depicts a multi-modal rear seat embodiment 600. The rear seat embodiment 600 includes an angled surface 605. The rear seat 615 deploys along a pivot motion 610. The rear seat once deployed extends along a surface 620. The surface may, for example, receive items below and/or on the surface.

FIG. 7 depicts a multi-modal rear seat rear seat folding configurations 700. The rear seat folding configurations 700 include a first rear seat 705 in a seat mode. The rear seat folding configurations include floor 720. The rear seat folding configurations include a folded bottom of a rear seat 710. The rear seat folding configurations include the opposing bottom surface of the rear seat pivot coupled to the rear seat. The pair of seats may, for example, be independently rotate from each other.

Although various embodiments have been described with reference to the figures, other embodiments are possible.

Although an exemplary system has been described with reference to FIGS. 1-7, other implementations may be deployed in other industrial, scientific, medical, commercial, and/or residential applications.

Within industrial applications the rear back seats may, for example, be customized to include fans and video screens for users of the golf cart. In scientific applications, offroad vehicles may, for example, be customized with fans and/or video screens in the rear to assist scientists traveling off road. Within medical applications the integrated speaker system into the seat backs may, for example, be used to deliver emergency broadcasts or safety messaging. Commercially, embodiments may, for example, be used to amplify promotional or informational broadcasts. In residential communities, these vehicles become conduits for communal announcements or personal leisure, blending technology with everyday convenience and enhancing the quality of interactions in numerous environments.

In industrial settings, some rear seat embodiments could morph into mobile command centers for onsite project management or emergency response units. Scientific applications use the rear seat configuration for field research stations, equipped with necessary tools and storage. The medical field may, for example, benefit from rear seat embodiments transforming into compact, mobile treatment stations for ambulances or health outreach vehicles, addressing urgent care needs on-the-go. Commercially, the rear seat embodiments could enhance logistics and delivery services by doubling as secure storage or an organizer for goods, documents, and equipment. In residential contexts (e.g., within recreational vehicles, golf carts, and off-terrain vehicles) the rear seat embodiments could serve multiple family needs-from storage solutions to makeshift dining or sleeping arrangements, embodying a blend of utility, comfort, and innovation that addresses a wide range of activities and requirements. The rear seat's multi-modal approach may, for example, optimize space and functionality.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as a [*** 9V] (nominal) batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may include, for example, an LCD (liquid crystal display). A display device (e.g., monitor) may, for example, be used for displaying information to the user. Some implementations may, for example, include a keyboard and/or pointing device (e.g., mouse, trackpad, trackball, joystick), such as by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IOT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

Some embodiments may, for example, relate to a seat back configured for a speaker for a golf cart and/or ATV. In an illustrative example, the seat back includes a predetermined area for the speaker to be installed, which may be mounted onto the pod of the vehicle. The predetermined area for the speaker will be positioned in a raised position, allowing for optimal sound distribution. Various embodiments may advantageously include a speaker installed into the predetermined area, coupled to a computer processing unit in the dash of the vehicle, and a controller in the rear of the vehicle for audio adjustments.

Some embodiments, may, for example, enhance the audio experience for passengers, provide customizable audio control for different seating positions, and integrate seamlessly with the vehicle's design and functionality. Additionally, the inclusion of a controller in the rear allows for audio adjustments, catering specifically to the needs of rear passengers in potentially a four-seater configuration, thus offering an elevated level of audio personalization and control within the vehicle.

In some embodiments, the multi-modal rear vehicle seat may, for example, include multiple modes. The multi-modal rear vehicle seat may, for example, include a folding device. The multi-modal rear vehicle seat may, for example, be used as a flat surface. The seat bottom may, for example, fold flat. The seat bottom may, for example, fold flat such that the whole seat bottom is located to make the deck completely flat. The seat bottom may, for example, include storage below the seat. The seat bottom may, for example, fold forward such that it converts a 4-seater vehicle into a 2-seater vehicle.

Some embodiments may, for example, include a folding device. The folding device may, for example, be used to fold the seat into a rear storage area. Some embodiments include a sliding-folding device. The sliding-folding device may, for example, be used to fold the seat into a rear storage area. The storage area may, for example, include an elevated perimeter. The storage area may, for example, include groves to provide traction, and/or drainage for liquids. The storage area may, for example, be completely flat. A second storage area may, for example, be situated underneath the seat.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A configured seat back and rear seating system comprising:
a vehicle;
an affixed backrest extending along a longitudinal axis;
a pair of configured front seat backs comprising:
at least one speaker and air conditioning modules,
a central cup holder,
a top handle affixed to the rear of the front seats; and,
a plurality of intersecting multi-modal rear vehicle seat independently pivotally coupled along a front of the multi modal seats configured such that the rear of the plurality of the seats may rotate along a front pivot wherein:
a seating mode the plurality of rear seats are configured such that the rear of the seat intersects the longitudinal axis of the affixed backrest; and,
a stowage mode configured such that the at least one rear of the plurality of the rear vehicle seats are extended to couple to an extended rear portion of a front seat.

2. The configured seat back and rear seating system of claim 1, further comprising two opposing nets configured to extend along the exterior rear seat to the rear of the front seat.

3. The configured seat back and rear seating system of claim 1, wherein the vehicle comprises a golf cart.

4. The configured seat back and rear seating system of claim 1, wherein the vehicle comprises an all-terrain vehicle.

5. The configured seat back and rear seating system of claim 1, wherein the vehicle comprises a canopy supported by a series of struts coupled to the vehicle.

6. The configured seat back and rear seating system of claim 1, wherein front seat backs comprises a mesh configured to store items.

7. The configured seat back and rear seating system of claim 1, wherein front seat backs further comprises a charging port.

8. A configured seat back and rear seating system comprising:
a vehicle;
an affixed backrest extending along a longitudinal axis; and,
a plurality of intersecting multi-modal rear vehicle seat independently pivotally coupled along a front of the multi modal seats configured such that the rear of the plurality of the seats may rotate along a front pivot wherein:
a seating mode the plurality of rear seats are configured such that the rear of the seat intersects the longitudinal axis of the affixed backrest; and,
a stowage mode configured such that the at least one rear of the plurality of the rear vehicle seats are extended to couple to an extended rear portion of a front seat.

9. The configured seat back and rear seating system of claim 8, further comprising a pair of configured front seat backs comprising at least one speaker and air conditioning modules.

10. The configured seat back and rear seating system of claim 8, further comprising a pair of configured front seat backs comprising a central cup holder.

11. The configured seat back and rear seating system of claim 8, further comprising a pair of configured front seat backs comprising a top handle affixed to the rear of the front seats.

12. The configured seat back and rear seating system of claim 8, further comprising two opposing nets configured to extend along the exterior rear seat to the rear of the front seat.

13. The configured seat back and rear seating system of claim 8, wherein the vehicle comprises a canopy supported by a series of struts coupled to the vehicle.

14. The configured seat back and rear seating system of claim 8, wherein the vehicle comprises a golf cart.

15. The configured seat back and rear seating system of claim 8, wherein the vehicle comprises an all-terrain vehicle.

16. The configured seat back and rear seating system of claim 8, wherein the vehicle comprises an electric vehicle.

17. The configured seat back and rear seating system of claim 8, wherein the vehicle comprises a front seat with an adjustable seat bottom and foldable armrest underneath a seat pod configured to receive the lip of the rear seat back.

18. The configured seat back and rear seating system of claim 8, wherein the vehicle comprises an hinged trunk comprising an affixed tether between a rear of the trunk to a rear of the vehicle.

19. The configured seat back and rear seating system of claim 8, wherein the front pivot comprises at least one hinge per seat.

20. The configured seat back and rear seating system of claim 8, wherein the front pivot comprises two hinges per seat.
